(19) United States
(12) Patent Application Publication
(10) Pub. No.: US 2007/0210528 A1
(43) Pub. Date: Sep. 13, 2007

(54) FUEL SEAL

(75) Inventor: Philip Baber, Guelph (CA)

Correspondence Address: DIMOCK STRATTON LLP, 20 QUEEN STREET WEST SUITE 3202, BOX 102, TORONTO, ON, M5H 3R3, US

(73) Assignee: POLY-NOVA TECHNOLOGIES INC., Guelph (CA)

(21) Appl. No.: 11/678,267

(22) Filed: Feb. 23, 2007

(30) Foreign Application Priority Data
Feb. 27, 2006 (CA) 2,537,673

(51) Int. Cl. F16J 15/32

(52) U.S. Cl. 277/549

(57) ABSTRACT

An overmolded fuel seal for preventing the leakage of fuel and fuel vapours in external fuel tank applications in a vehicle fuel system. The fuel seal comprises a fuel-resistant carrier that is overmolded with fuel-resistant elastomer. The carrier comprises flexible sealing lips and in the preferred embodiment an anchoring means, for attachment of an elastomer portion comprising sealing lips. The elastomer portion can be mechanically and/or chemically attached to the carrier. The compressed elastomer provides primary liquid and vapour sealing and the flexible lips of the carrier provide a secondary seal.

### FIELD OF THE INVENTION

This invention relates to seals. In particular, the invention relates to an overmolded seal that is particularly useful as a fuel seal for low fuel emission applications.

### BACKGROUND OF THE INVENTION

Fuel vapours leaking out into the atmosphere from a vehicle fuel system may cause air pollution and thus are hazardous to the environment. New vehicle requirements such as PZEV (Partial Zero Emission Vehicle) emission regulations require that minimal hydrocarbon content be emitted from the vehicle. This applies to the complete fuel system including the fuel tank, fuel valves, fuel level sender unit and all connections between these components.

Highly fuel resistant thermoplastic resins are used for the fuel tank and fuel valve barrier layers, which effectively minimize hydrocarbon emissions from these components of the fuel system. However, the elastomeric seals that seal the connections between these components still present problematic levels of hydrocarbon emissions. Although some fuel valves use elastomer seals, many of these valves reduce emission levels by welding or heat staking the HDPE (high density polyethylene) body of the valve to the HDPE outer layer of the fuel tank. However, this is a more involved and costly procedure than using a seal and is not practical in some cases, such as the aperture in the fuel tank where the fuel level sender unit is attached. The fuel level sender unit is mechanically assembled to the tank using a seal compressed axially between the fuel sender unit flange and the floor of a groove formed in the tank wall, and no chemical joining of the components occurs.

Numerous seal designs and/or materials have been used to seal this interface, including standard O-ring, quad ring and H-ring seals. These seals are used in a ‘face sealing’ configuration, where the elastomer is compressed axially between the sender unit flange and the tank groove floor.

### BRIEF DESCRIPTION OF THE DRAWINGS

In drawings in which similar references are used in different figures to denote similar components and which illustrate by way of example only a preferred embodiment of the invention,

FIG. 1 is a schematic cross-section of the fuel seal between the fuel sender unit and fuel tank in a fuel system;

FIG. 2 is a cross-section through the carrier of the fuel seal of FIG. 1;

FIG. 3 is an enlarged cross-section through the fuel seal of FIG. 1;

FIG. 4 is a partial plan view taken from the top of FIG. 3; and

FIG. 5 is a cross-section of a further embodiment of the fuel seal of the invention.

### DETAILED DESCRIPTION OF THE INVENTION

An object of the present invention is to provide an improved fuel seal 3 that reduces either liquid or vapour fuel emissions from the fuel tank 2, or both. The fuel seal 3 can be used with valves (for example flow control valves, inlet check valves, not shown), gaskets, or any other component that is externally connected to the fuel tank 2 and/or anywhere lower fuel leakage emissions are desired.

The seal 3 is located between the fuel tank 2 and a mating external component (for example, the fuel sender unit 1 or fuel valves) in a face sealing configuration. The seal 3 may be seated in a groove 4 formed about the outlet of the fuel tank 2, as is conventional.

In the preferred embodiment the carrier 7 is formed from a semi-rigid thermoplastic such as nylon but thermosetting materials or other suitable (preferably semi-rigid) materials can also be used. The elastomer portion 13 may for example be formed from a fluorocarbon elastomer, which is highly fuel-impermeable. Other suitable materials will be well known to those skilled in the art. If desired the elastomer can be mechanically and/or chemically attached to the carrier 7.

The design of the fuel seal 3 allows flexibility of the carrier material in the axial direction, allowing for axial deflection under the applied engineering strain. In the illustrated embodiment, shown by way of example only, the seal 3 is located in the annular groove 4 formed around the aperture of the fuel tank 2, and is compressed between the fuel level sender unit 1 and the tank 2 by means of external mechanical locking mechanism, for example a conventional ‘cam lock’ (not shown). In the installed condition, the compressed elastomeric material provides primary liquid and vapour sealing while the flexible lips of the carrier also contact the mating tank and fuel level sender unit surfaces, providing a secondary seal and thus impart to the seal 3 a very high permeation resistant barrier to fuel vapour. The engineering modulus properties of the carrier material add to the sealing stress generated by the engineering strain applied to the elastomer.

As shown in FIG. 3, the seal 3 of the invention comprises a carrier 7 and an elastomer portion 13. The fuel seal 3 may be designed to fit existing groove sizes designed for current O-rings and other rubber seals. The fuel seal 3 is preferably semi-rigid to assist in automated assembly, and may be symmetrical for ease of assembly. The fuel seal 3 is able to provide adequate sealing where low emissions are required, for example with PZEV (Partial Zero Emission Vehicle) and ZEV (Zero Emission Vehicle) applications.

The carrier 7, shown in FIG. 2, comprises a body 7a from which extend flexible, preferably substantially resilient, carrier lips 8 which are flared axially outwardly so as to be compressed between the mating parts (e.g. fuel level sender unit 1 and tank 2) when in use. Connecting pockets 10 may be intermittenly provided in the carrier body 7a for anchoring the elastomer portion 13, as will be described below. The outer portion of the carrier body 7a may optionally be cored out, as at 11, to reduce material content of the carrier 7, and thereby reduce costs.

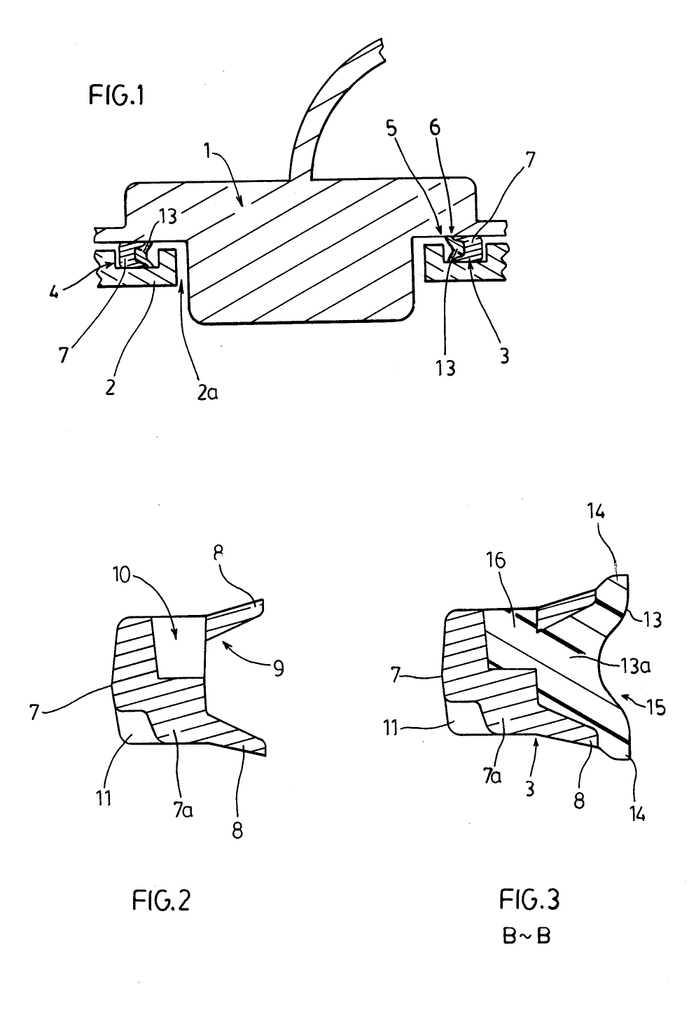

The carrier 7 provides secondary sealing contact along the flexible lips 8 and produces a high permeation-resistant barrier, as seen in FIG. 1. The carrier 7 is designed to be flexible in the axial direction (relative to the aperture 2a through the tank 2, and preferably resilient so that the carrier 7 imparts additional sealing stresses to the elastomer portion 13 due to its inherent material modulus.

The elastomer portion 13 consists of elastomeric lips 14 extending outwardly from a body 13a which may be undercut to form a recess as at 15 to allow for seal compression. This also creates a pressure energizing area of the seal 3. The radially exterior surfaces of the elastomeric lips 14 are preferably flared so as to extend radially beyond the carrier lips 8 and also preferably extend axially beyond the carrier lips 8. Increased sealing forces from the elastomeric sealing lips can be achieved by eliminating the undercut as at 15, and as shown in FIG. 5. There is higher compression without the undercut 15. Therefore if higher compression is not required, then the undercut 15 may be present.

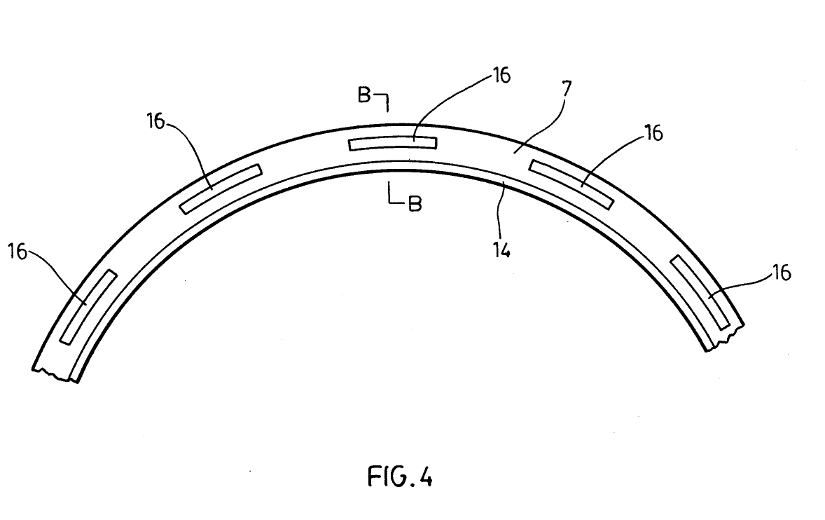

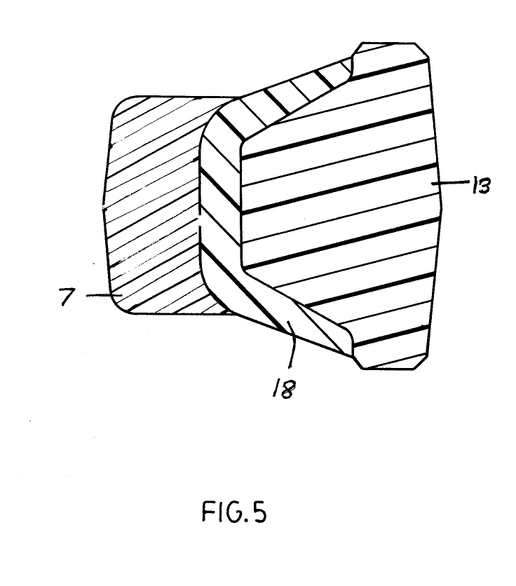

During the overmolding process the elastomer portion 13 may intrude into the connecting pockets 10 in the carrier body 7a, forming intermittent anchors 16 (as shown in FIG. 4) that can assist to affix the elastomer portion 13 to the carrier 7. The pockets 10 are preferably provided generally uniformly about the seal.

The elastomer portion 13 may be affixed to the carrier 7 by chemically bonding the elastomer portion 13 to the undercut portion 9 of the carrier 7. Chemical bonding of the carrier 7 to the elastomer portion 13 may for example be effected by dipping a thermoplastic carrier 7 in silane (or another chemical coupling) solution and then overmolding the elastomer portion 13 to the carrier 7. As a result, there is a chemical attraction between the elastomer and the silane, and between the silane and the thermoplastic carrier 7, which forms a chemical bond in the overmolded product. This may be in addition to, or as an alternative to, the mechanical anchoring of the elastomer portion 13 to the carrier 7. In other cases the geometry of the carrier undercut 9 coupled with the resilience of the elastomer portion 13 may be sufficient to retain the elastomer portion 13 within the carrier undercut 9.

In use, as shown generally in FIG. 1, the external accessory such as a fuel level sender unit 1 is installed into the aperture 2a of the fuel tank 2, with the seal 3 installed into the fuel tank seal groove 4. The elastomer portion 13 creates a primary liquid and vapour seal, while the carrier lips 8 provide a secondary vapour seal which renders the seal 3 substantially impermeable to the fuel in either the liquid or gaseous phase.

The permeation resistance versus component cost can be adjusted using appropriate elastomer and carrier material selections, for example, elastomers have differing levels of fluorine content. As is known in the art, the thermoplastic material of the carrier may be replaced with thermoset resin or other suitable semi-rigid material.

For ultra low emission applications, the seal 3 may comprise an additional high permeation-resistant layer 18, as shown in FIG. 5. The additional layer 18 may be formed from an extremely high permeation-resistant material, for example a fluoropolymer thermoplastic. The fluoropolymer is preferably applied over the carrier 7 by overmolding the high permeation-resistant layer 18 to the carrier 7. The elastomer portion 13 is then overmolded and chemically bonded to the composite carrier consisting of 7 and 18.

In this fashion, using a minimal thickness of the high permeation-resistant layer 18 will minimize cost impact while increasing hydrocarbon permeation resistance. There may be any number of additional high permeation-resistant layers 18 incorporated in a similar fashion, which may include similar composite layers. The high permeation-resistant layer 18 serves as a back-up layer with high permeation resistance, to prevent hydrocarbons passing through the elastomer portion 13, but does not provide an effective liquid seal against the fuel tank 2. Accordingly, the radial edges of the high permeation-resistant layer 18 are preferably inset from the radial edges of the elastomer portion 13, so that sealing is effected by the lips 14 of the elastomer portion without interference by the high permeation-resistant layer 18.

Various embodiments of the present invention having been thus described in detail by way of example, it will be apparent to those skilled in the art that variations and modifications may be made without departing from the invention. The invention includes all such variations and modifications as fall within the scope of the appended claims.

What is claimed is:

1. A seal for sealing between mating components, comprising
a carrier comprising a body comprising resilient carrier lips extending from the body, and
an elastomer portion retained by the carrier, comprising elastomeric lips disposed between the carrier lips and extending beyond the carrier lips,
whereby when compressed between the mating components the elastomeric lips form a first seal against the mating components and the carrier lips form a second seal against the mating components.

2. The seal of claim 1 wherein the seal is annular.

3. The seal of claim 2 wherein the carrier lips are flared outwardly from the body.

4. The seal of claim 3 wherein the elastomeric lips are flared outwardly.

5. The seal of claim 4 wherein the elastomeric lips extend radially beyond the carrier lips.

6. The seal of claim 2 wherein the elastomer portion is undercut to form a recess between the elastomeric lips.

7. The seal of claim 2 wherein the elastomer portion intrudes into pockets formed in the carrier, to anchor the elastomer portion to the carrier.

8. The seal of claim 7 wherein the pockets are provided generally uniformly about the seal.

9. The seal of claim 2 wherein the elastomer portion is chemically bonded to the carrier.

10. The seal of claim 9 wherein the elastomer portion is chemically bonded to the carrier by silane.

11. The seal of claim 2 comprising at least one additional high permeation-resistant layer comprising a high permeation resistant material applied over a surface of the carrier.

12. The seal of claims 11 wherein the additional high permeation-resistant layer comprises a fluoropolymer thermoplastic.

13. A method of making a seal for sealing between mating components, comprising the steps of:
a. molding a carrier comprising a body comprising resilient carrier lips extending from the body, and
b. overmolding to the carrier an elastomer portion comprising elastomeric lips disposed between the carrier lips and extending beyond the carrier lips.

14. The method of claim 13 comprising, during step b., permitting the elastomer portion to intrude into pockets formed in the carrier, to anchor the elastomer portion to the carrier.

15. The method of claim 13 comprising, during step b., the step of chemically bonding the elastomer portion to the carrier.

16. The method of claim 15 comprising, before step b., the step of dipping the carrier in a chemical coupling solution.

17. The method of claim 16 wherein the chemical coupling solution comprises silane.

18. The method of claim 13 further comprising, before step b., the step of applying at least one additional high permeation-resistant layer comprising a high permeation resistant material over a surface of the carrier.

19. The method of claim 18 wherein the additional high permeation-resistant layer is overmolded to the carrier.

20. The method of claim 18 wherein the additional high permeation-resistant layer comprises a fluoropolymer thermoplastic.
